(19) United States
(12) Patent Application Publication
(10) Pub. No.: US 2014/0093310 A1
(43) Pub. Date: Apr. 3, 2014

(54) CLAMP ASSEMBLY FOR A BICYCLE

(71) Applicant: Chao-Hu Chen, Taichung City (TW)

(72) Inventor: Chao-Hu Chen, Taichung City (TW)

(21) Appl. No.: 13/629,621

(22) Filed: Sep. 28, 2012

(51) Int. Cl. F16B 2/02

(52) U.S. Cl. 403/290

(57) ABSTRACT

A clamp assembly for a bicycle includes a clamp having an enclosing hole, a gap and two locking members. The enclosing hole communicates with the gap. Each locking member has a locking hole opened therethrough. A threaded member is passed through the two locking holes of the two locking members. An enforcing ring is assembled onto an outer periphery of the clamp. Under this arrangement, when the enforcing ring is assembled onto the clamp, a stress in the clamp is dispersed uniformly so as to fasten a bicycle tubing stably.

### BACKGROUND OF THE INVENTION

1. Field of the Invention

The present invention relates to a clamp, and more particularly to a clamp assembly for a bicycle.

2. Description of Related Art

A conventional clamp device comprises a body having a gap defined between two ends thereof, the body having a through hole defined thereof, a ring member being assembled into the body and being attached to an inner wall of the through hole, the ring member having a breach defined between two ends thereof, the breach being reducible, the body being sleevable on a middle tubing, the middle tubing having an axial slot defined thereof, the middle tubing having a receiving hole opened at a center thereof, a post tubing being insertable into the receiving hole, the gap of the body and the axial slot of the middle tubing being opposite to each other, the body having two locking portions respectively formed at two ends thereof, each locking portion having a threaded hole defined thereon, a threaded member being insertable into the two threaded member.

Under this arrangement, firstly, the ring member is assembled into the body and the body sleeves on the middle tubing; and then, the post tubing is inserted into the receiving hole of the middle tubing; thereby, the threaded member is inserted into the two threaded holes of the body to assemble the body to the middle tubing so as to tightly fasten the middle tubing with the post tubing which is connected to part of a bicycle. Moreover, because the gap of the body and the axial slot of the middle tubing are opposite to each other, a stress of the middle tubing is dispersed uniformly to the body so as to prevent the middle tubing from breaking or deforming.

However, the conventional clamp device has one disadvantage as following.

In order to disperse the stress of the middle tubing uniformly, one position of the gap must be opposite to another position of the axial slot. In addition, the number of elements of the conventional clamp device is so many. Therefore, installing the conventional clamp device to the bicycle is time consuming and difficult.

The present invention has arisen to mitigate and/or obviate the disadvantages of the conventional.

### SUMMARY OF THE INVENTION

The main objective of the present invention is to provide a clamp assembly for a bicycle.

To achieve the objective, a clamp assembly for a bicycle comprises a clamp, the clamp being C-shaped, the clamp having an enclosing hole opened therethrough, the clamp having a gap defined between two ends thereof, the enclosing hole communicating with the gap, the clamp having two locking members respectively protruded from two ends thereof, each locking member having a locking hole opened therethrough, a threaded member, the threaded member passed through the two locking holes of the two locking members, an enforcing ring, the enforcing ring assembled onto an outer periphery of the clamp. Wherein, each locking member has a groove opened thereon; each groove is adjacent to the clamp; each groove comprises a cavity and a neck opening; one end of each neck opening communicates with each corresponding cavity; another end of the neck opening communicates with an outside relative to the groove; the enforcing ring has two protruded members formed at two ends thereof; the two protruded members correspond to the two grooves respectively; each protruded member comprises an end portion and a neck portion; the two end portions correspond to the two cavities respectively; the two neck portions correspond to the two neck openings respectively; the two protruded members of the enforcing ring are slidably inserted into the two grooves of the clamp and the two protruded members are respectively engaged with the two grooves so as to fasten the enforcing ring on the clamp; a thickness of the enforcing ring is thinner than another thickness of the clamp; each locking hole has a locking portion defined at an inner wall thereof; the threaded member has a threaded end defined at one end thereof; the threaded end of the threaded member is inserted into the locking portions of the two locking members so that the clamp is tightly assembled on the bicycle tubing. Under this arrangement, when the enforcing ring is assembled onto the clamp, a stress in the clamp is dispersed uniformly so as to fasten a bicycle tubing stably.

A clamp assembly for a bicycle comprises a clamp, the clamp being C-shaped, the clamp having an enclosing hole opened therethrough, the clamp having a gap defined between two ends thereof, the enclosing hole communicating with the gap, the clamp having two locking members respectively protruded from two ends thereof, each locking member having a locking hole opened therethrough, an enforcing ring, the enforcing ring assembled into the clamp, the enforcing ring attached to an inner wall of the enclosing hole, the enforcing ring having two extruded wings protruded from two ends thereof, the two extruded wings attached to two side walls of the gap respectively, each extruded wing having a through hole opened thereof, the two through holes corresponding to the two locking holes of the two locking members respectively, a threaded member, the threaded member passed through the two locking members and the two extruded wings. Wherein, the clamp has a slot opened around an outer periphery thereof; the slot is opened from one end of the clamp to another end of the clamp; the weight of the clamp is reduced because of the slot; a thickness of the enforcing ring is thinner than another thickness of the clamp; each locking hole has a locking portion defined at an inner wall thereof; the threaded member has a threaded end defined at one end thereof; the threaded end of the threaded member is inserted into the locking portions of the two locking members so that the clamp is tightly assembled on the bicycle tubing. Under this arrangement, when the enforcing ring is assembled onto the clamp, a stress in the clamp is dispersed uniformly so as to fasten a bicycle tubing stably.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a first embodiment of a clamp assembly for a bicycle of the present invention;

FIG. 2 is a perspective view for showing the clamp assembly for a bicycle is assembled to a bicycle tubing;

FIG. 3 is a cross-sectional view of the clamp for a bicycle;

FIG. 4 is an exploded view of a second embodiment of the present invention;

FIG. 5 is a perspective view of the second embodiment of the present invention;

FIG. 6 is a cross-sectional view along line 6-6 shown in FIG. 5

FIG. 7 is an exploded view of the present invention for showing a clamp has a slot opened around an outer periphery thereof;

FIG. 8 is a perspective view of the present invention for showing the clamp has the slot opened around the outer periphery thereof; and

FIG. 9 is a cross-sectional view along line 9-9 shown in FIG. 8.

### DETAILED DESCRIPTION OF THE INVENTION

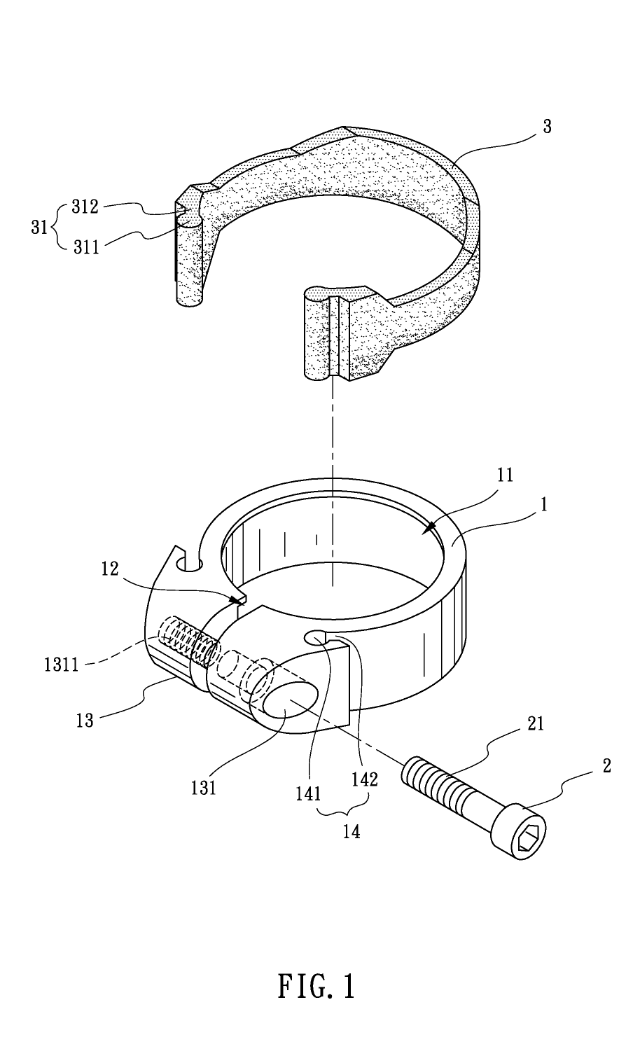

Referring to FIGS. 1-3, a main type of a first embodiment of a clamp assembly for a bicycle in accordance with the present invention comprises a clamp 1, a treaded member 2 and an enforcing ring 3.

The clamp 1 is C-shaped. The clamp 1 has an enclosing hole 11 opened therethrough. The clamp 1 has a gap 12 defined between two ends thereof. The enclosing hole 11 communicates with the gap 12. The clamp 1 has two locking members 13 respectively protruded from two ends thereof. Each locking member 13 has a locking hole 131 opened therethrough.

The threaded member 2 is passed through the two locking holes 131 of the two locking members 13.

The enforcing ring 3 is assembled onto an outer periphery of the clamp 1.

Under this arrangement, when the enforcing ring 3 is assembled onto the clamp 1, a stress in the clamp 1, produced upon assembling to a bicycle tubing 4, is dispersed uniformly so as to fasten the bicycle tubing 4 stably.

Referring to FIG. 1, each locking member 13 has a groove 14 opened thereon. Each groove 14 is adjacent to the clamp 1. Each groove 14 comprises a cavity 141 and a neck opening 142. One end of each neck opening 142 communicates with each corresponding cavity 141. Another end of the neck opening 142 communicates with an outside relative to the groove 14. The enforcing ring 3 has two protruded members 31 formed at two ends thereof. The two protruded members 31 correspond to the two grooves 14 respectively. Each protruded member 31 comprises an end portion 311 and a neck portion 312. The two end portions 311 correspond to the two cavities 141 respectively. The two neck portions 312 correspond to the two neck openings 142 respectively. Therefore, the two protruded members 31 of the enforcing ring 3 are slidably inserted into the two grooves 14 of the clamp 1; and then, the two protruded members 31 are respectively engaged with the two grooves 14 so as to fasten the enforcing ring 3 on the clamp 1.

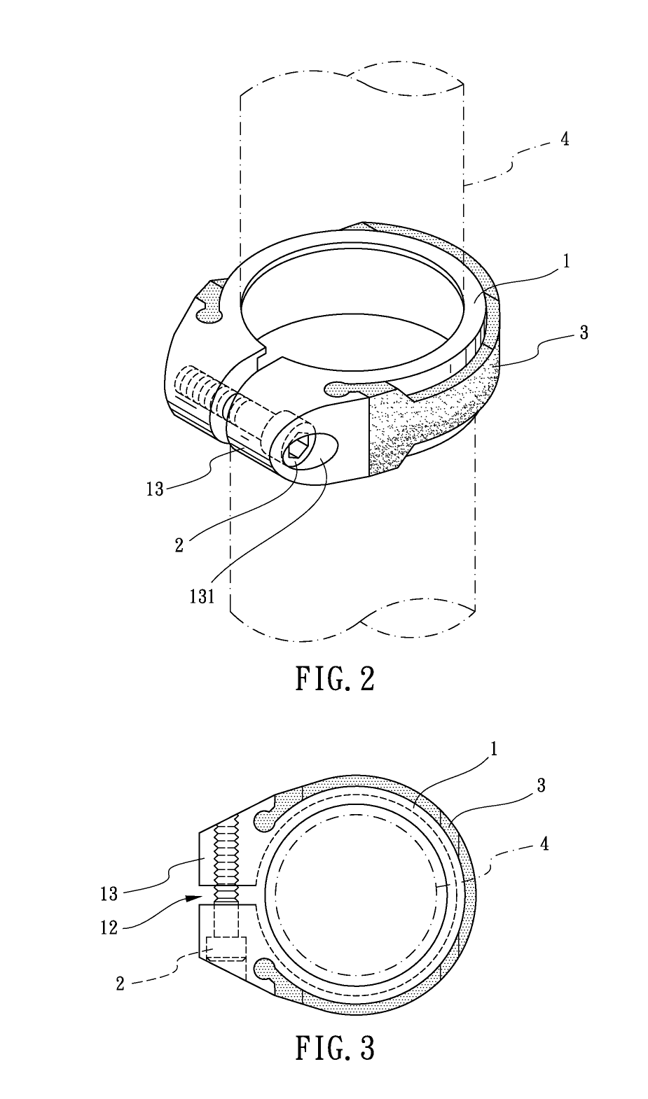

Referring to FIG. 2, the enforcing ring 3 is assembled on the clamp 1 firstly; then, the bicycle tubing 4 is passed through the clamp 1; and then, the threaded member 2 is threaded into the clamp 1 so as to shrink the enclosing hole 11 and the gap 12 of the clamp 1. Under this arrangement, the stress in the clamp 1 is dispersed uniformly with the enforcing ring 3 so as to prevent the clamp 1 and the bicycle tubing 4 from breaking or deforming. Moreover, the enforcing ring 3 is stably assembled onto the clamp 1 because of the engagement between the grooves 14 of the clamp 1 and the protruded members 31 of the enforcing ring 3.

Referring to FIGS. 1-3, the further details of the present invention are shown as following:

1. A thickness of the enforcing ring 3 is thinner than another thickness of the clamp 1. The enforcing ring 3 could be made of carbon fiber so as to reduce the weight and to retain the mechanical properties of the enforcing ring 3 (The material of the enforcing ring 3 is not limited in the present invention).

2. Each locking hole 131 has a locking portion 1311 defined at an inner wall thereof. The threaded member has a threaded end 21 defined at one end thereof. Under this arrangement, the threaded end 21 of the threaded member 2 is inserted into the locking portions 1311 of the two locking members 13 so that the clamp 1 is tightly assembled on the bicycle tubing 4. In addition, a position of the clamp 1 relative to the bicycle tubing 4 is adjustable by locking the threaded member 2 into the locking member 13 or by unlocking the threaded member 2 out of the locking member 13.

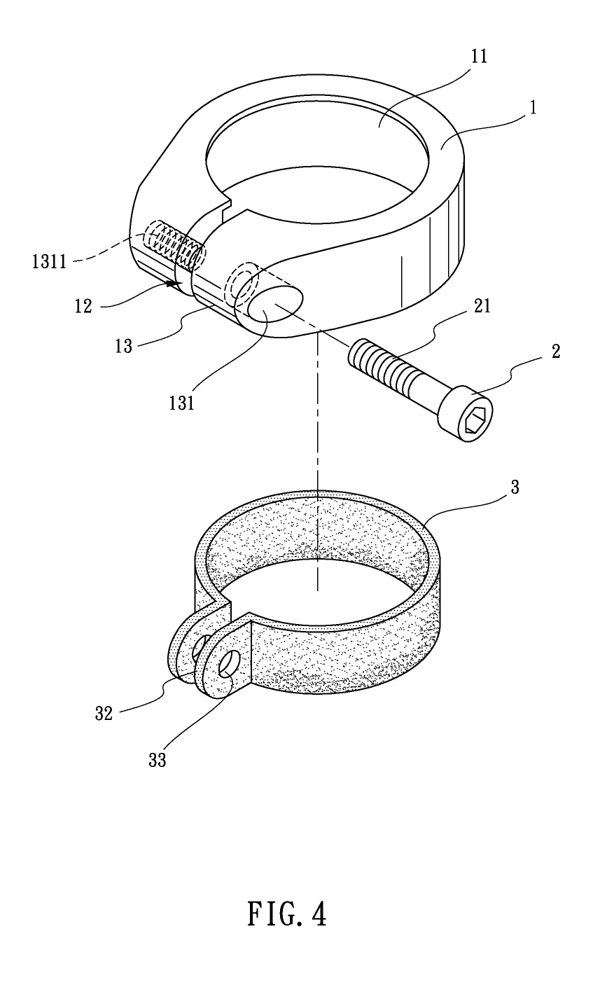

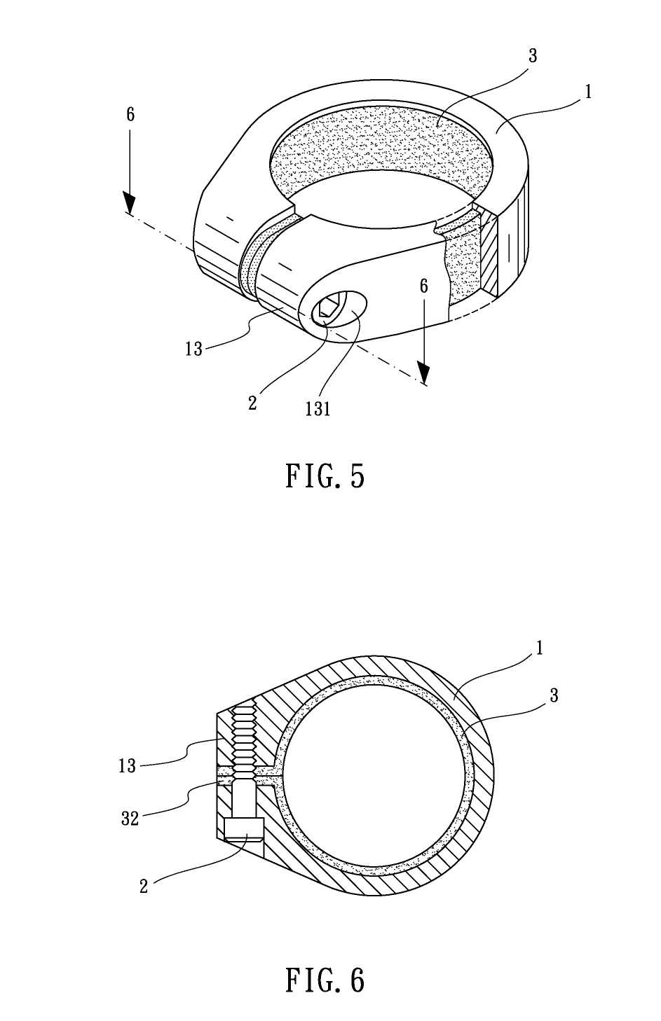

FIGS. 4-6 show one sub type of the first embodiment in accordance with the present invention (Only the differences between the main type of the first embodiment and the sub type of the first embodiment are further described). The enforcing ring 3 is assembled into the clamp 1. The enforcing ring 3 is attached to an inner wall of the enclosing hole 11. The enforcing ring 3 has two extruded wings 32 protruded from two ends thereof. The two extruded wings 32 are attached to two side walls of the gap 12 respectively. Each extruded wing 32 has a through hole 33 opened thereof. The two through holes 33 correspond to the two locking holes 131 of the two locking members 13 respectively. Under this arrangement, when the threaded member 2 is passed through the two locking members 13 and the two extruded wings 32, the stress in the clamp 1 is dispersed uniformly with the enforcing ring 3 so as to fasten the bicycle tubing stably.

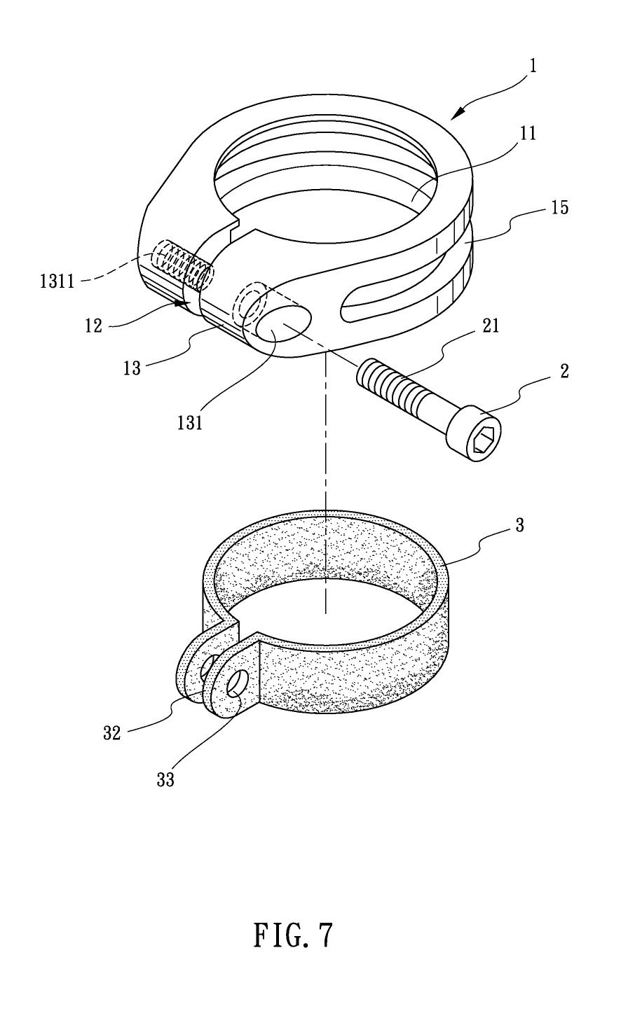

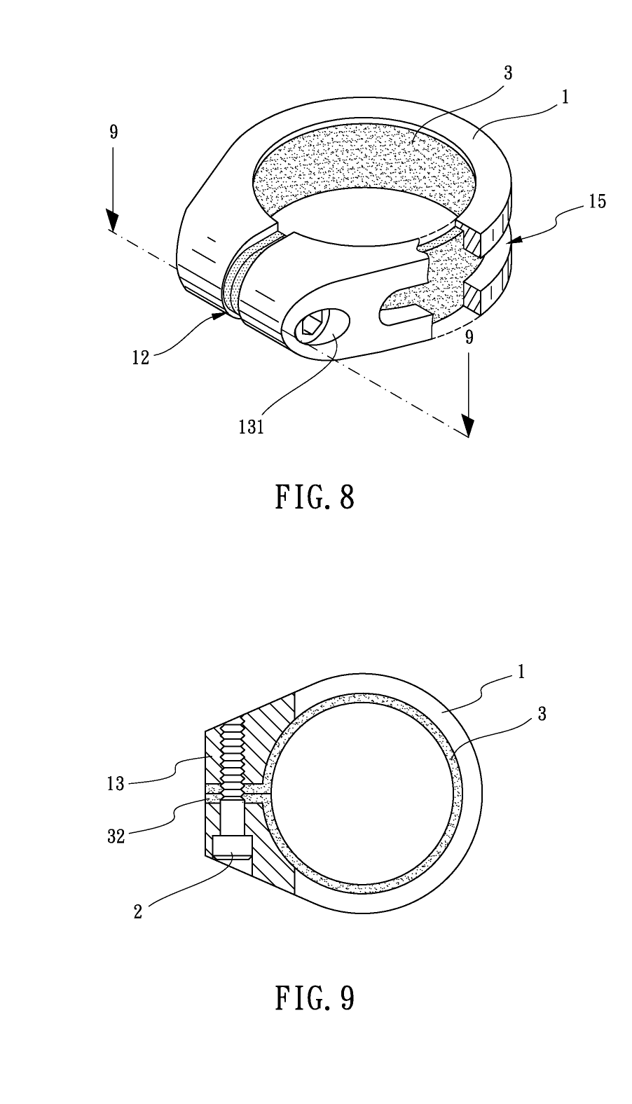

FIGS. 7-9 show a second embodiment of the clamp assembly for a bicycle in accordance with the present invention (Only the differences between the first embodiment and the second embodiment are further described). The clamp 1 has a slot 15 opened around an outer periphery thereof. The slot 15 is opened from one end of the clamp 1 to another end of the clamp 1. Therefore, the weight of the clamp 1 is reduced because of the slot 15.

Regarding to the first and second embodiments, a color of the clamp 1 is different from another color of the enforcing ring 3. Under this arrangement, the position of the enforcing ring 3 can be distinguished easily because of said difference of color.

All in all, the present invention has following advantages.

Firstly, since the structure of the present invention is simple and the elements used in the present invention is less than the conventional, installing the present invention is time saving and easy.

Secondly, the stress in the clamp 1 could be uniformly dispersed to the enforcing ring 3 so as to protect the bicycle tubing 4 and the clamp 1 from deforming and breaking.

Although the invention has been explained in relation to its preferred embodiment, it is to be understood that many other possible modifications and variations can be made without departing from the spirit and scope of the invention as hereinafter claimed.

What is claimed is:

1. A clamp assembly for a bicycle comprising:
a clamp, the clamp being C-shaped, the clamp having an enclosing hole opened therethrough, the clamp having a gap defined between two ends thereof, the enclosing hole communicating with the gap, the clamp having two locking members respectively protruded from two ends thereof, each locking member having a locking hole opened therethrough;
a threaded member, the threaded member passed through the two locking holes of the two locking members; and
an enforcing ring, the enforcing ring assembled onto an outer periphery of the clamp;
wherein when the enforcing ring is assembled onto the clamp, a stress in the clamp is dispersed uniformly so as to fasten a bicycle tubing stably.

2. The clamp assembly for a bicycle as claimed in claim 1, wherein each locking member has a groove opened thereon; each groove is adjacent to the clamp; each groove comprises a cavity and a neck opening; one end of each neck opening communicates with each corresponding cavity; another end of the neck opening communicates with an outside relative to the groove; the enforcing ring has two protruded members formed at two ends thereof; the two protruded members correspond to the two grooves respectively; each protruded member comprises an end portion and a neck portion; the two end portions correspond to the two cavities respectively; the two neck portions correspond to the two neck openings respectively; the two protruded members of the enforcing ring are slidably inserted into the two grooves of the clamp and the two protruded members are respectively engaged with the two grooves so as to fasten the enforcing ring on the clamp.

3. The clamp assembly for a bicycle as claimed in claim 1, wherein a thickness of the enforcing ring is thinner than another thickness of the clamp.

4. The clamp assembly for a bicycle as claimed in claim 1, wherein each locking hole has a locking portion defined at an inner wall thereof; the threaded member has a threaded end defined at one end thereof; the threaded end of the threaded member is inserted into the locking portions of the two locking members so that the clamp is tightly assembled on the bicycle tubing.

5. A clamp assembly for a bicycle comprising:
a clamp, the clamp being C-shaped, the clamp having an enclosing hole opened therethrough, the clamp having a gap defined between two ends thereof, the enclosing hole communicating with the gap, the clamp having two locking members respectively protruded from two ends thereof, each locking member having a locking hole opened therethrough;
an enforcing ring, the enforcing ring assembled into the clamp, the enforcing ring attached to an inner wall of the enclosing hole, the enforcing ring having two extruded wings protruded from two ends thereof, the two extruded wings attached to two side walls of the gap respectively, each extruded wing having a through hole opened thereof, the two through holes corresponding to the two locking holes of the two locking members respectively; and
a threaded member, the threaded member passed through the two locking members and the two extruded wings;
wherein when the enforcing ring is assembled to the clamp, a stress in the clamp is dispersed uniformly so as to fasten a bicycle tubing stably.

6. The clamp assembly for a bicycle as claimed in claim 5, wherein the clamp has a slot opened around an outer periphery thereof; the slot is opened from one end of the clamp to another end of the clamp; the weight of the clamp is reduced because of the slot.

7. The clamp assembly for a bicycle as claimed in claim 5, wherein a thickness of the enforcing ring is thinner than another thickness of the clamp.

8. The clamp assembly for a bicycle as claimed in claim 5, wherein each locking hole has a locking portion defined at an inner wall thereof; the threaded member has a threaded end defined at one end thereof; the threaded end of the threaded member is inserted into the locking portions of the two locking members so that the clamp is tightly assembled on the bicycle tubing.
